(19) United States
(12) Patent Application Publication
(10) Pub. No.: US 2025/0037615 A1
(43) Pub. Date: Jan. 30, 2025

(54) Installation Structure and Electronic Device

(71) Applicant: BOE Technology Group Co., Ltd., Beijing (CN)

(72) Inventor: Wenbin WANG, Beijing (CN)

(21) Appl. No.: 18/282,560

(22) PCT Filed: Feb. 20, 2023
(86) PCT No.: PCT/CN2023/077067

§ 371 Date: Sep. 18, 2023

(30) Foreign Application Priority Data
Apr. 27, 2022 (CN) 202210451436.7

(51) Int. Cl. G09F 3/20

(52) U.S. Cl. CPC G09F 3/208; G09F 3/204

(57) ABSTRACT

Embodiments of the present disclosure provide an installation structure and an electronic device. The installation structure includes a main body part, and a connector and a magnetic assembly disposed on the main body part, the connector is configured to be connected with an electronic price tag. The magnetic assembly includes a first member and a second member that are magnetically attracted to each other, the first member is fixed to the main body part, and the second member is configured to be fixed to an installation foundation.

### CROSS-REFERENCE TO RELATED APPLICATIONS

The present application is a U.S. National Phase Entry of International Application PCT/CN2023/077067 having an international filing date of Feb. 20, 2023, which claims priority of Chinese patent application No. 202210451436.7, entitled “Installation Structure and Electronic Device”, filed to the CNIPA on Apr. 27, 2022, the contents of which should be interpreted as being incorporated into the present application by reference.

### TECHNICAL FIELD

The present disclosure relates to the field of mechanical structures, and particularly to an installation structure and an electronic device.

### BACKGROUND

At present, after a new retail concept is put forward, with a development of the new retail industry, an retail enterprise begins to increase investment in information solutions, an online e-commerce began to value market opportunities and bring Internet genes into the market, and offline traditional retailers begin to try information solutions, and electronic price tags gradually occupy supermarkets and affects our lives. At the same time, merchants also put forward higher requirements on installation of electronic price tags.

### SUMMARY

An embodiment of the present disclosure provides an installation structure and an electronic device.

In a first aspect, an embodiment of the present disclosure provides an installation structure, including a main body part, and a connector and a magnetic assembly disposed on the main body part,
the connector is configured to be connected with an electronic price tag;
the magnetic assembly includes a first member and a second member that are magnetically attracted to each other, the first member is fixed to the main body part, and the second member is configured to be fixed to an installation foundation.

In some embodiments, the main body part includes a back plate and a side plate fixedly connected with the back plate, a plane where the back plate is located intersects with a plane where the side plate is located, the first member is disposed on the back plate, and the connector is disposed on the side plate.

In some embodiments, the back plate is provided with a placement groove and at least a portion of the first member is fixed into the placement groove.

In some embodiments, the installation structure further includes: a first bonding part disposed in the placement groove, and the first member is bonded in the placement groove through the first bonding part.

In some embodiments, the placement groove has an opening facing the installation foundation and the first member protrudes from the opening.

In some embodiments, a distance between a surface of the first member close to the installation foundation and a surface of the back plate away from the installation foundation is between 3 mm and 3.5 mm.

In some embodiments, a magnetic attraction force of the first member is greater than a total gravity of the installation structure and the electronic price tag.

In some embodiments, a viscous adhesive force of the first bonding part is greater than a total gravity of the main body part, the connector and the electronic price tag.

In some embodiments, the back plate is perpendicular to the side plate.

In some embodiments, the connector is configured to be detachably connected with the electronic price tag.

In some embodiments, the connector includes a first buckle group and a second buckle group that are disposed opposite to each other, the first buckle group includes at least one first buckle, and the second buckle group includes at least one second buckle; and
the at least one first buckle and the at least one second buckle are both configured to be snapped in hook grooves on the electronic price tag.

In some embodiments, the first buckle group and the second buckle group are arranged at interval in a height direction of the installation structure.

In some embodiments, the installation structure further includes a second bonding part and the second bonding part is configured to bond the second member to the installation foundation.

In some embodiments, a viscous adhesive force of the second bonding part is greater than a total gravity of the installation structure and the electronic price tag.

In a second aspect, an embodiment of the present disclosure provides an electronic device, including an electronic price tag and an installation structure of the first aspect, and the electronic price tag is connected with the connector.

In some embodiments, the electronic price tag includes a display part and a projection part located at a side of the display part and the connector is connected with the projection part.

### BRIEF DESCRIPTION OF DRAWINGS

Accompanying drawings are used for providing a further understanding of the present disclosure and constitute a part of the specification, and are used for explaining the present disclosure together with the following specific implementations but does not constitute limitations on the present disclosure. In the drawings:

FIG. 1 is a schematic diagram of an application of an installation structure according to an embodiment of the present disclosure.

FIG. 2 is an exploded schematic diagram of an installation structure, an electronic price tag and an installation foundation according to an embodiment of the present disclosure.

FIG. 3 is a partial schematic diagram of an installation structure according to an embodiment of the present disclosure.

FIG. 4 is a partial schematic diagram of another installation structure according to an embodiment of the present disclosure.

FIG. 5 is a partial exploded view of an installation structure according to an embodiment of the present disclosure.

FIG. 6 is a partial schematic diagram of another installation structure according to an embodiment of the present disclosure.

FIG. 7 is a partial exploded view of another installation structure according to an embodiment of the present disclosure.

FIG. 8 is a schematic structural view of an electronic device according to an embodiment of the present disclosure.

### DETAILED DESCRIPTION

Specific implementations of the present disclosure are described in detail below with reference to the accompanying drawings. It should be understood that the specific implementations described herein are only intended to illustrate and explain the present disclosure and are not intended to limit the present disclosure.

In order to make objectives, technical solutions, and advantages of the embodiments of the present disclosure more clear, the technical solutions of the embodiments of the present disclosure will be clearly and completely described below with reference to the drawings of the embodiments of the present disclosure. Apparently, the described embodiments are a part of the embodiments of the present disclosure, not all of the embodiments. Based on the described embodiments of the present disclosure, all other embodiments obtained by those of ordinary skills in the art without inventive effort are within the protection scope of the present disclosure.

Unless otherwise defined, technical terms or scientific terms used in the embodiments shall have common meanings understood by those with ordinary skills in the art to which the present disclosure pertains. The “first”, “second” and similar terms used in the present disclosure do not indicate any order, quantity, or importance, but are used only for distinguishing different components. Likewise, wording such as “include”, “contain” and the like mean that elements or objects appearing before the wording cover elements or objects listed after the wording and their equivalents, but do not exclude other elements or objects. “Connect”, “join”, or a similar term is not limited to a physical or mechanical connection, but may include an electrical connection, whether direct or indirect. “Upper”, “lower”, “left”, “right”, etc., are only used to represent relative position relations, and when an absolute position of a described object is changed, the relative position relation may also be correspondingly changed.

With development of electronic price tags, the electronic price tags are more and more applied in supermarkets, home stores and other scenes. In some embodiments, a screw and a nut are used to connect an installation structure of an electronic price tag to a shelf, such connection method may bring inconvenience to replacement of the electronic price tag and damages integrity of the shelf.

In some other embodiments, a whole strip of plastic guide rail is used as an installation structure to fix an electronic price tag on a shelf of a store, but a structural size of the plastic guide rail is large and is not easy to hide, which affects the look and feel of the shelf. A plastic material will wear and tear after many times of replacement of electronic price tags, and their service life is short. In addition, when replacing the electronic price tag, the staff needs to accurately align a track position of the guide rail structure, which is unable to operate quickly or conveniently and is inconvenient to disassemble.

To solve at least one of the above technical problems, an embodiment of the present disclosure provides an installation structure.

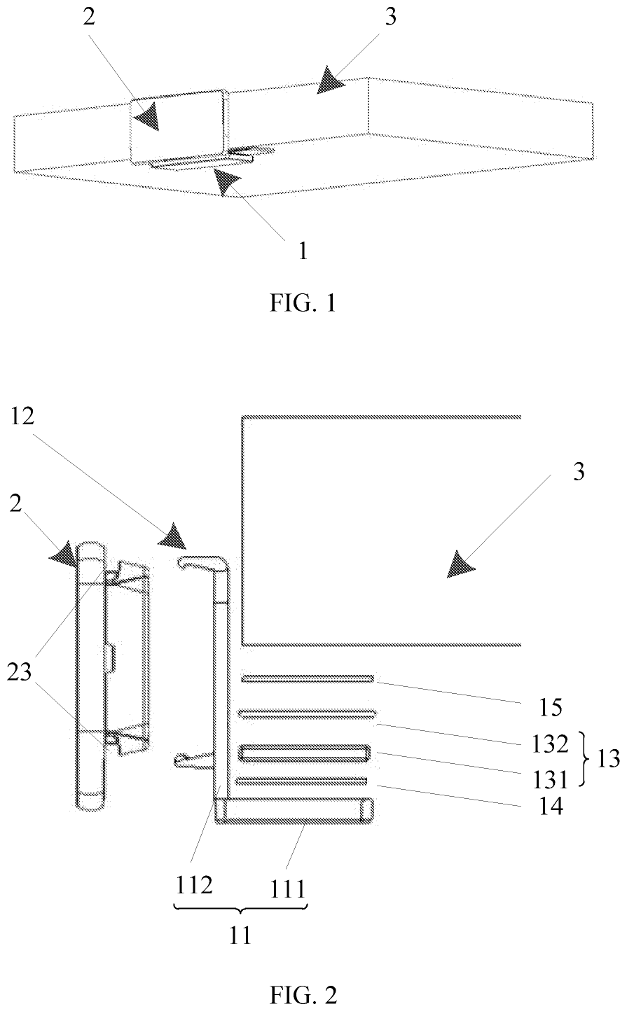

FIG. 1 is a schematic diagram of an application of an installation structure according to an embodiment of the present disclosure, and FIG. 2 is an exploded schematic diagram of an installation structure, an electronic price tag and an installation foundation according to an embodiment of the present disclosure. In some embodiments, as shown in FIG. 1 and FIG. 2, an installation structure 1 is used for installing an electronic price tag 2 on an installation foundation 3 such as a shelf. The installation structure 1 includes a main body part 11, and a connector 12 and a magnetic assembly 13 disposed on the main body part 11. The connector 12 is configured to be connected with an electronic price tag 2. The magnetic assembly 13 includes a first member 131 and a second member 132 that are magnetically attracted to each other, the first member 131 is fixed to the main body part 11 and the second member 132 is configured to be fixed to the installation foundation 3. The magnetic assembly 13 is provided to magnetically connect the installation structure 1 with the installation foundation 3, thereby avoiding presence of destructive installation marks on a surface of the installation foundation 3 and ensuring a structural integrity of the installation foundation 3. At the same time, the first member 131 and the second member 132 of the magnetic assembly 13 are easy to adsorb each other or be separated, so that when the electronic price tag 2 needs to be disassembled or replaced, the first member 131 and the second member 132 can be directly separated, thus improving convenience of use.

It should be noted that the aforementioned installation foundation 3 may be a shelf, a cabinet, etc.

Since the first member 131 and the second member 132 are connected in a magnetically attractive manner, a material of one of the first member 131 and the second member 132 may be a permanent magnet material, and a material of the other may be an iron material. For example, the first member 131 is made of a magnet and the second member 132 is made of iron.

In one example, the installation foundation 3 may be made of an iron material, in which case the first member 131 may be directly provided as a magnet so as to be magnetically connected with the installation foundation 3, and the second member 132 is no longer required to be provided between the first member 131 and the installation foundation 3.

In addition, in order to ensure a stability of a connection between the first member 131 and the second member 132, contact surfaces of the first member 131 and the second member 132 can be provided as planar, and an area of magnetic contact surfaces of the first member 131 and the second member 132 can be enlarged as much as possible. In one example, the first member 131 is a magnet, whose surface facing the second member 132 is rectangular with an area of 60 mm*20 mm, and the second member 132 is made of iron. An orthographic projection of the second member 132 on the installation foundation 3 covers an orthographic projection of the first member 131 on the installation foundation 3, so that the surface of the first member 131 close to the installation foundation 3 is entirely in magnetic contact with the second member 132.

The aforementioned first member 131 may be any one of cube, cuboid, cylinder, elliptical cylinder, or the like, which is not limited in the present disclosure.

It should be noted that a size of a surface of the first member 131 facing the second member 132 is adjusted adaptively with a change of a size of the electronic price tag 2. In one embodiment, when the surface of the first member 131 facing the second member 132 is rectangular, a ratio of a length to a width of the surface is between 2.5 and 3.5, which may be 2.5, 3 or 3.5 for example. For example, the length is 60 mm, the width is 20 mm, and the ratio of the length to the width of the surface is 3.

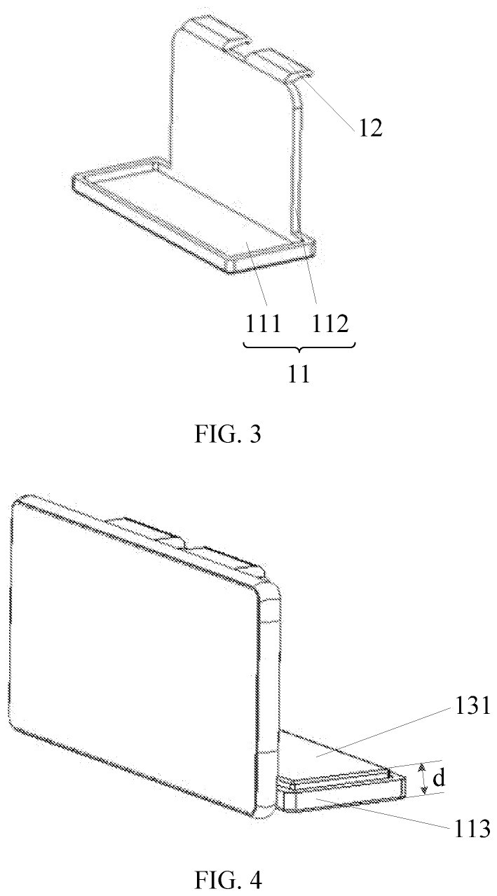

FIG. 3 is a partial schematic diagram of an installation structure according to an embodiment of the present disclosure. In some embodiments, as shown in FIG. 2 and FIG. 3, the main body part 11 includes a back plate 111 and a side plate 112 fixedly connected with the back plate 111, and a plane where the back plate 111 is located intersects a plane where the side plate 112 is located, for example, the back plate 111 is perpendicular to the side plate 112. It should be noted that when the back plate 111 is perpendicular to the side plate 112, an angle between the back plate 111 and the side plate 112 is between 80 and 100 degrees. The first member 131 is disposed on the back plate 111 and the connector 12 is disposed on the side plate 112.

In one example, the back plate 111 and the side plate 112 may be formed integrally, which may be made of a lightweight metal material, such as titanium alloy, aluminum alloy, etc., and may also be made of an organic material, such as acrylic, polystyrene, etc., and the embodiments of the present disclosure are not limited thereto.

In this configuration, when the electronic price tag 2 is exhibited, at least a part of the side plate 112 can be shielded by the electronic price tag 2, and the back plate 111 and the side plate 112 are disposed interestedly and fixedly connected to each other, so that the side plate 112 is located below the installation foundation 3, thus the entire installation structure 1 can not only shown the electronic price tag 2, but also reduce the presence feeling of the main body part 11 of the installation structure 1.

FIG. 4 is a partial schematic diagram of another installation structure according to an embodiment of the present disclosure. In some embodiments, as shown in FIG. 2-FIG. 4, the back plate 111 is provided with a placement groove 113, at least a portion of the first member 131 is fixed in the placement groove 113, thereby at least the portion of the first member 131 is hidden in the placement groove 113 to make a structure of the installation structure 1 more compact.

It should be noted that an opening shape of the placement groove 113 may be any one structure of rectangle, square, trapezoid, semicircle, circle, or ellipse, and the embodiments of the present disclosure are not limited thereto. In addition, the opening shape of the placement groove 113 may be the same as a shape of the first member 131 and a size of the opening may be slightly greater than the size of the first member 131.

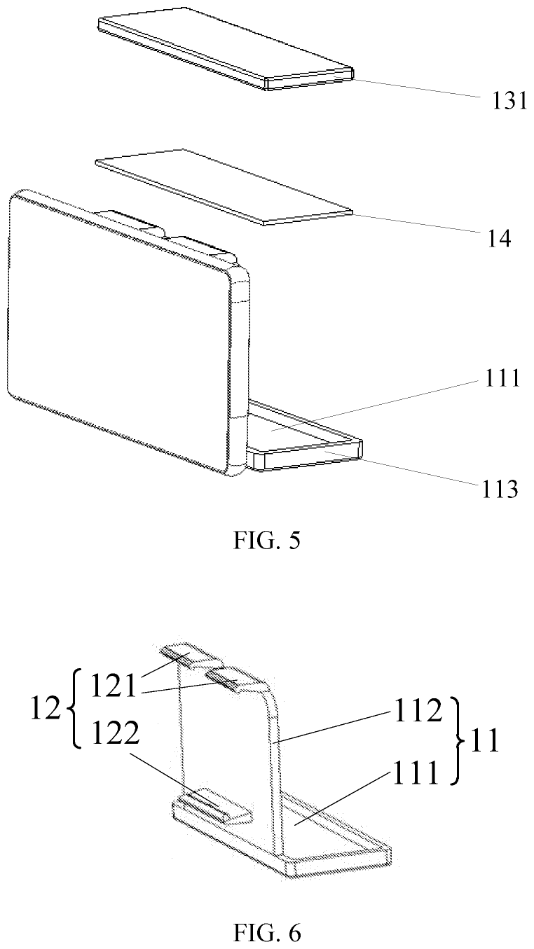

FIG. 5 is a partial exploded view of an installation structure according to an embodiment of the present disclosure. As shown in FIG. 5, the installation structure 1 further includes a first bonding part 14 disposed in the placement groove 113, and the first member 131 is bonded in the placement groove 113 through the first bonding part 14, so as to fix a position of the first member 131, avoid relative movement between the first member 131 and the placement groove 113, and further ensure stable connection between the installation structure 1 and the installation foundation 3.

In some other embodiments, the first member 131 may also be fixed in the placement groove 113 by other connection manners, for example, the first member 131 is welded in the placement groove 113, or the first member 131 is fixed in the placement groove 113 by a screw-nut connection, or the first member 131 and the placement groove 113 are connected by other fasteners, and the embodiments of the present disclosure are not limited thereto.

In one example, the first bonding part 14 is located at the bottom of the first member 131, and an orthographic projection of the first bonding part 14 on the back plate 111 may be substantially overlapped with an orthographic projection of the first member 131 on the back plate 111, so as to increase an area of the bonding surface between the first bonding part 14 and the first member 131 as much as possible to improve the bonding stability.

As shown in FIG. 2-FIG. 5, the placement groove 113 has an opening facing the installation foundation 3, and the first member 131 protrudes from the opening so as to magnetically attract the second member 132, while the second member 132 is fixed to the installation foundation 3, thereby enabling the first member 131 to be firmly adsorbed on the installation foundation 3.

In some embodiments, a ratio of a thickness d1 of the first member 131 to a groove depth d2 of the placement groove 113 is between 1 and 2, i.e., ½ d1<d2<d1, so that the first member 131 protrudes from the opening of the placement groove 113 and the stability of adsorption between the first member 131 and the second member 132 is ensured.

In one example, the groove depth of the placement groove113 is between 1.8 mm and 2.2 mm, for example 2 mm. A thickness of the first member 131 is between 2.3 mm and 2.7 mm, for example, the thickness of the first member 131 may be any one of 2.3 mm, 2.5 mm, and 2.7 mm.

In some embodiments, as shown in FIG. 4, a distance d between the surface of the first member 131 close to the installation foundation 3 and a surface of the back plate 111 away from the installation foundation 3 is between 3 mm and 3.5 mm. For example, d may be any one of 3 mm, 3.3 mm, and 3.5 mm. That is, the sum of the thickness of the first member 131, a thickness of the first bonding part 14, and a thickness of the bottom of the back plate 111 is d, so that a size of the installation structure 1 below the installation foundation 3 is reduced, and a problem of unpleasant appearance caused by a large size of the installation structure 1 is avoided.

It should be noted that the distance d between the surface of the first member 131 close to the installation foundation 3 and the surface of the back plate 111 away from the installation foundation 3 refers to a distance between the first member 131 and the back plate 111 which are in the bonding state through the first bonding part 14.

In some embodiments, as shown in FIG. 1 and FIG. 2, the first member 131 and the second member 132 are magnetically attracted to each other, so that the installation structure 1 can be fixed on the installation foundation 3, and the installation structure 1 is also connected with the electronic price tag 2, so that a magnetic attraction force of the first member 131 is greater than a total gravity of the installation structure 1 and the electronic price tag 2, avoiding a phenomenon that the magnetic attraction force between the first member 131 and the second member 132 is insufficient to support the installation structure 1 and the electronic price tag 2, causing them to fall off, thereby ensuring a installation stability of the installation structure 1 and the electronic price tag 2 on the installation foundation 3.

In some embodiments, as shown in FIG. 5, the first bonding part 14 is configured to bond the first member 131 and the back plate 111. The back plate 111 is fixedly connected with the side plate 112, the side plate 112 is provided with the connector 12, and the electronic price tag 2 is connected with the side plate 112 through the connector 12. Therefore, in some embodiments, a viscous adhesive force of the first bonding part 14 is configured to be greater than the total gravity of the main body part 11, the connector 12 and the electronic price tag 2, so as to avoid a phenomenon that the back plate 111 is separated from the first member 131 due to an insufficient viscous adhesive force of the first bonding part 14, resulting in damages to the installation structure 1 and the electronic price tag 2.

FIG. 6 is a partial schematic diagram of another installation structure according to an embodiment of the present disclosure. In some embodiments, as shown in FIG. 6, the connector 12 is configured to be detachably connected with the electronic price tag 2, thereby facilitating replacing the electronic price tag 2 at any time.

In some embodiments, as shown in FIG. 2 and FIG. 6, the connector 12 includes a first buckle group 121 and a second buckle group 122 that are disposed opposite to each other, both of the first buckle group 121 and the second buckle group 122 are configured to be snapped in hook grooves 23 on the electronic price tag 2. As shown in FIG. 3, the first buckle group 121 includes at least one first buckle, for example, the first buckle group 121 includes two first buckles, and the second buckle group 122 includes at least one second buckle, so as to improve the stability between the connector 12 and the electronic price tag 2 and avoid the electronic price tag 2 from falling and breaking.

In one example, the connector 12 and the main body part 11 may be formed integrally and a material of the connector 12 and the main body part 11 is a same as a material of the main body part 11.

In some embodiments, the first buckle group 121 and the second buckle group 122 are arranged at intervals in a height direction of the installation structure 1, the height direction refers to a direction of height of the installation structure 1 when the installation structure 1 is connected with the installation foundation 3. As shown in FIG. 5 the at least one first buckle and the at least one second buckle are provided in opposite directions, thereby fixing the electronic price tag 2 to the side plate 112.

It should be noted that the at least one first buckle and the at least one second buckle are fasteners for fixing the electronic price tag, and quantities of the at least one first buckle or the at least one second buckle can be configured according to the actual situation, and the embodiments of the present disclosure are not limited thereto.

In some other embodiments, the connector 12 may further include any one of a clamp and a guide rail structure, and the electronic price tag 2 can be clamped and fixed by the clamp, or the electronic price tag 2 can be fixed by embedding a protrusion on the electronic price tag 2 into a groove of the guide rail structure, all of the above connection manners can achieve the detachable connection between the connector 12 and the electronic price tag 2.

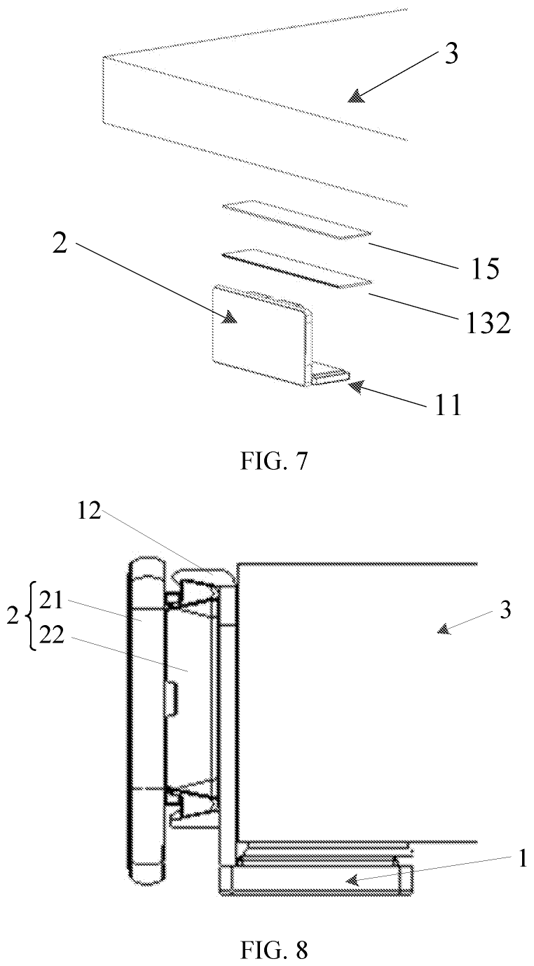

FIG. 7 is a partial exploded view of another installation structure according to an embodiment of the present disclosure. In some embodiments, as shown in FIG. 7, the installation structure 1 further includes a second bonding part 15, and the second bonding part 15 is configured to bond the second member 132 to the installation foundation 3.

In some other examples, the second member 132 may also be fixed to the installation foundation 3 by screw-nut connection.

As shown in FIG. 7, the second bonding part 15 is configured to bond the installation foundation 3 and the second member 132. The second member 132 is magnetically connected with the first member 131, and the first member 131 is bonded to the back plate 111 through the first bonding part 14. The back plate 111 is fixedly connected with the side plate 112, the side plate 112 is provided with a connector 12, and the electronic price tag 2 is connected with the side plate 112 through the connector 12, so that a viscous adhesive force of the second bonding part 15 is greater than the total gravity of the installation structure 1 and the electronic price tag 2, thus avoiding a phenomenon that the second member 132 is separated from the installation foundation 3 due to an insufficient viscous adhesive force of the second bonding part 15, resulting in damage to the installation structure 1 and the electronic price tag 2.

Both the first bonding part 14 and the second bonding part 15 in an embodiment of the present disclosure can be double-sided adhesive tape or a film layer formed after colloid curing. The aforementioned double-sided adhesive tape can be mesh double-sided adhesive tape, high-temperature double-sided adhesive tape, PVC adhesive tape and PVC electrical adhesive tape, double-sided glass cloth adhesive tape, foam double-sided adhesive tape, and the like, and the embodiments of the present disclosure are not limited thereto.

In one example, thicknesses of the first bonding part 14 and the second bonding part 15 are both between 0.7 mm and 1 mm, for example, any one of 0.7 mm, 0.8 mm, 0.9 mm, and 1 mm, and a thicknesses of the first bonding part 14 and a thickness of a second bonding part 15 may be same or different, and the embodiments of the present disclosure are not limited thereto.

FIG. 8 is a schematic structural view of an electronic device according to an embodiment of the present disclosure. As shown in FIG. 8, the electronic device includes an electronic price tag 2 and the aforementioned installation structure 1, and the electronic price tag 2 is connected with the connector 12.

The electronic price tag 2 includes a display part 21 and a projection part 22 located on a side of the display part 21 and the connector 12 is connected with the projection part 22.

It should be noted that the projection part 22 may be used for placing a battery of the electronic price tag 2 and the projection part 22 may be in a loop-shaped structure or a ring-shaped structure or other irregular-shaped structure, which is not limited herein.

In one example, the display part 21 may be any one of a liquid crystal display screen, an electronic ink screen, or an OLED display screen, and may also be another product or member having a display function, which is not limited in the present disclosure.

As shown in FIG. 1 and FIG. 8, the electronic price tag 2 is buckled with the installation structure 1 through the connector 12, the connector 12 of the installation structure 1 is disposed on the side plate 112, the side plate 112 is fixedly connected with the back plate 111, and the side plate 112 and the back plate 111 are in a vertical cross structure. The back plate 111 is bonded with the first member 131 through the first bonding part 14, the first member 131 is magnetically connected with the second member 132, and the second member 132 is fixed on the installation foundation 3 through the second bonding part 15. The electronic price tag 1 can shield the connector 12 and the side plate 112. The first bonding part 14 and the first member 131 are disposed in the placement groove 113 on the back plate 111, and the sum of the thickness of the first bonding part 14, the thickness of the first member 131, and the thickness of the bottom of the back plate 111 is only d, the first bonding part 14, the first member 131, the back plate 111, the second member 132 and the second bonding part 15 are all disposed under the installation foundation 3, which not only does not affect showing the electronic price tag 2, but also makes the installation structure 1 more compact and hides as many parts in the installation structure 1 as possible under the installation foundation 3.

In addition, the electronic price tag is detachably connected with the installation structure, which is convenient for replacing the electronic price tag. The installation structure includes a magnetic assembly, which is convenient for disassembly and installation, and can replace some parts of the installation structure (the connector, the side plate, the back plate, the placement groove, the first bonding part and the first member) together with the electronic price tag, thus improving the convenience of use. Moreover, the bonding connection and the magnetic attraction connection do cause damage to the installation foundation, thus ensuring the structural integrity of the installation foundation.

It is to be understood that the above embodiments are only exemplary embodiments employed for the purpose of illustrating the principles of the present disclosure, however the present disclosure is not limited thereto. To those of ordinary skills in the art, various modifications and improvements may be made without departing from the essence and substance of the present disclosure, and these modifications and improvements are also considered to be within the scope of the present disclosure.

1. An installation structure, comprising a main body part, and a connector and a magnetic assembly disposed on the main body part,
wherein the connector is configured to be connected with an electronic price tag;
the magnetic assembly comprises a first member and a second member that are magnetically attracted to each other, the first member is fixed to the main body part, and the second member is configured to be fixed to an installation foundation.

2. The installation structure according to claim 1, wherein the main body part comprises a back plate and a side plate fixedly connected with the back plate, a plane where the back plate is located intersects with a plane where the side plate is located, the first member is disposed on the back plate, and the connector is disposed on the side plate.

3. The installation structure according to claim 2, wherein the back plate is provided with a placement groove and at least a portion of the first member is fixed into the placement groove.

4. The installation structure according to claim 3, further comprising: a first bonding part disposed in the placement groove, and the first member is bonded in the placement groove through the first bonding part.

5. The installation structure according to claim 3, wherein the placement groove has an opening facing the installation foundation and the first member protrudes from the opening.

6. The installation structure according to claim 2, wherein a distance between a surface of the first member close to the installation foundation and a surface of the back plate away from the installation foundation is between 3 mm and 3.5 mm.

7. The installation structure according to claim 1, wherein a magnetic attraction force of the first member is greater than a total gravity of the installation structure and the electronic price tag.

8. The installation structure according to claim 4, wherein a viscous adhesive force of the first bonding part is greater than a total gravity of the main body part, the connector and the electronic price tag.

9. The installation structure according to claim 2, wherein the back plate is perpendicular to the side plate.

10. The installation structure according to claim 1, wherein the connector is configured to be detachably connected with the electronic price tag.

11. The installation structure according to claim 10, wherein the connector comprises a first buckle group and a second buckle group that are disposed opposite to each other, the first buckle group comprises at least one first buckle and the second buckle group comprises at least one second buckle; and
the at least one first buckle and the at least one second buckle are both configured to be snapped in hook grooves on the electronic price tag.

12. The installation structure according to claim 11, wherein the first buckle group and the second buckle group are arranged at interval in a height direction of the installation structure.

13. The installation structure according to claim 1, further comprising a second bonding part and the second bonding part is configured to bond the second member to the installation foundation.

14. The installation structure according to claim 13, wherein a viscous adhesive force of the second bonding part is greater than a total gravity of the installation structure and the electronic price tag.

15. An electronic device, comprising an electronic price tag and the installation structure according to claim 1, wherein the electronic price tag is connected with the connector.

16. The electronic device according to claim 15, wherein the electronic price tag comprises a display part and a projection part located at a side of the display part and the connector is connected with the projection part.

17. The installation structure according to claim 2, wherein a magnetic attraction force of the first member is greater than a total gravity of the installation structure and the electronic price tag.

18. The installation structure according to claim 3, wherein a magnetic attraction force of the first member is greater than a total gravity of the installation structure and the electronic price tag.

19. The installation structure according to claim 4, wherein a magnetic attraction force of the first member is greater than a total gravity of the installation structure and the electronic price tag.

20. The installation structure according to claim 5, wherein a magnetic attraction force of the first member is greater than a total gravity of the installation structure and the electronic price tag.
